(19) United States
(12) Patent Application Publication
(10) Pub. No.: US 2014/0248069 A1
(43) Pub. Date: Sep. 4, 2014

(54) IMAGE FORMING APPARATUS, AND METHOD OF PRODUCING BELT MEMBER USED IN THE APPARATUS

(71) Applicants: Hidetaka Kubo, Kanagawa (JP); Jun Aoto, Kanagawa (JP)

(72) Inventors: Hidetaka Kubo, Kanagawa (JP); Jun Aoto, Kanagawa (JP)

(73) Assignee: RICOH COMPANY, LTD., Tokyo (JP)

(21) Appl. No.: 14/138,779

(22) Filed: Dec. 23, 2013

(30) Foreign Application Priority Data
Mar. 1, 2013 (JP) 2013-040908

(51) Int. Cl. G03G 15/01; B32B 15/06

(52) U.S. Cl. CPC G03G 15/162
USPC 399/302; 264/171.15

(57) ABSTRACT

An image forming apparatus includes an image bearer; an image developer developing a latent image formed on the image bearer with a toner to form a toner image thereon; a ring-shaped intermediate transfer belt rotatably stretched by plural tension rollers, and the toner image is first transferred on; a curving roller contacting an outer surface of the intermediate transfer belt the toner image is transferred on and curving the belt inside; and a transferer secondly transferring the toner image on the intermediate transfer belt to a recording medium. The intermediate transfer belt has a double-layered structure formed of an inner layer and an outer layer each including a same resin.

### CROSS-REFERENCE TO RELATED APPLICATIONS

This patent application is based on and claims priority pursuant to 35 U.S.C. §119 to Japanese Patent Application No. 2013-040908, filed on Mar. 1, 2013, in the Japan Patent Office, the entire disclosure of which is hereby incorporated by reference herein.

### BACKGROUND

1. Technical Field

The present invention relates to an image forming apparatus such as a printer, a facsimile and a copier; and a method of producing a belt member used in the image forming apparatus.

2. Description of the Related Art

An image forming apparatus using an intermediate transfer belt which is a belt member as an intermediate transferer is effectively used as a full-color image forming apparatus or a multicolor image forming apparatus sequentially transferring plural color component images such as color image information and multicolor image information in a layer to produce color prints. Conventionally, the intermediate transfer belts are mostly formed of a resin such as polyimide resins and polyamideimide resins.

Japanese published unexamined application No. JP-H8-146706-A discloses an image forming apparatus includes a curving roller contacting an outer surface of an intermediate transfer belt which is a belt member to curve the belt from outside to inside, which is stretched by plural tension rollers to form a ring. A part of the intermediate transfer belt is curved inside to save an inside wasteful space thereof and downsize the image forming apparatus.

When an image forming apparatus including an intermediate transfer belt is left in a high-temperature and high-humidity environment for long periods, a part of the intermediate transfer belt the tension roller or the curving roller contacts tends to curl along a contact surface of the roller. When the intermediate transfer belt has a curl, the belt abnormally rotates, resulting in cracks and ruptures thereof in the worst case.

A part of the belt having a curl tends to be curved and bulged even when the belt rotates. Therefore, when the intermediate transfer belt having a large curl is used, a transfer pressure of a toner to a recording medium therefrom is not uniformed and the toner is unevenly transferred, resulting in uneven image density.

When a concentration detector detecting a concentration of a toner is located facing an outer surface of the intermediate transfer belt, a distance from a toner image thereon to the concentration detector largely varies when the belt has a large curl. Therefore, the concentration of a toner on the intermediate transfer belt is not precisely detected and is not properly controlled, resulting in abnormal images.

In an image forming apparatus including no curving roller, the intermediate transfer belt is only curved from inside to outside by the tension roller located inside. Therefore, there is no problem in practical use only if curls to inside are reduced.

However, in an image forming apparatus including a curving roller, the intermediate transfer belt is not only curved from inside to outside by the tension roller located inside, but also curved from outside to inside by the curving roller located outside. Therefore, not only the curls to inside, but also curls to outside need to be reduced.

Because of these reasons, a need exists for an image forming apparatus capable of reducing curls to inside and outside of the intermediate transfer belt while being downsized.

### SUMMARY

Accordingly, one object of the present invention is to provide an image forming apparatus capable of reducing curls to inside and outside of the intermediate transfer belt while being downsized.

Another object of the present invention is to provide a method of producing a belt member used in the image forming apparatus.

These objects and other objects of the present invention, either individually or collectively, have been satisfied by the discovery of an image forming apparatus, including an image bearer; an image developer developing a latent image formed on the image bearer with a toner to form a toner image thereon; a ring-shaped intermediate transfer belt rotatably stretched by plural tension rollers, and the toner image is first transferred on; a curving roller contacting an outer surface of the intermediate transfer belt the toner image is transferred on and curving the belt inside; and a transferer secondly transferring the toner image on the intermediate transfer belt to a recording medium. The intermediate transfer belt has a double-layered structure formed of an inner layer and an outer layer each including a same resin.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating a layer composition of an embodiment of the intermediate transfer belt for use in the present invention;

FIG. 2 is a schematic view illustrating an embodiment of the image forming apparatus of the present invention;

FIG. 3 is a schematic view illustrating a main composition of a transferer in the embodiment of the image forming apparatus of the present invention;

FIG. 4 is a schematic view illustrating a curl applicator; and

FIGS. 5A and 5B are schematic views for explaining a curl angle.

### DETAILED DESCRIPTION

The present invention provides an image forming apparatus capable of reducing curls to inside and outside of the intermediate transfer belt while being downsized.

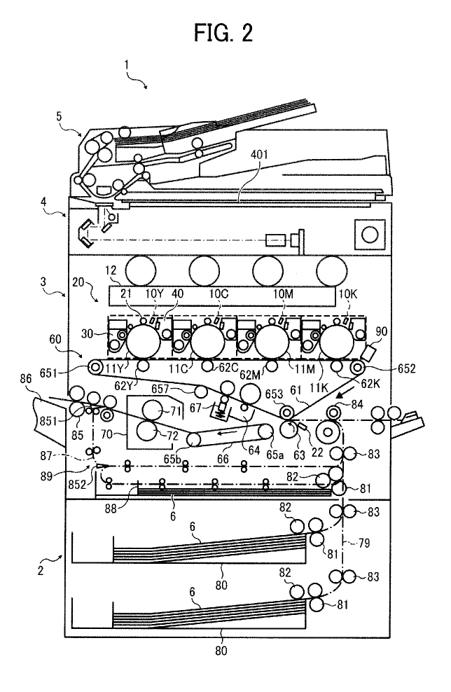

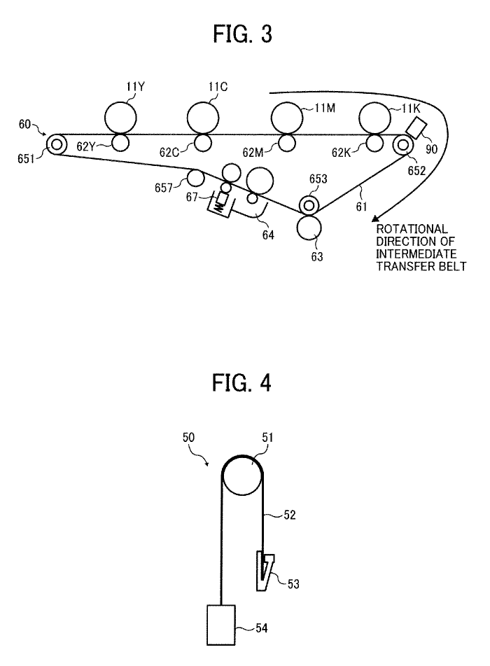

FIG. 2 is a schematic view illustrating an embodiment of the image forming apparatus of the present invention. FIG. 3 is a schematic view illustrating a main composition of a transferer 60 in the embodiment of the image forming apparatus of the present invention.

FIG. 2 is an embodiment of typified tandem image forming apparatus having an intermediate transfer belt, and the present invention is not limited to the following composition.

An image forming apparatus 1 includes an automatic document feeder (ADF) 5 automatically feeding documents loaded thereon, a scanner (reader) 4 reading the documents, an image former 3 forming a toner image, and a paper feeder 2 including and feeding a recording paper 6 below.

The paper feeder 2 includes a feed paper cassette 80 containing the recording paper 6, a paper feed roller 82 feeding the recording paper 6 contained in the feed paper cassette 80 toward a transfer route 79, and a separation roller 81 separating the recording paper 6 fed. A recording paper 6 fed by the paper feed roller 82 and separated one by one by the separation roller 81 is transferred by a transfer roller 83 in the transfer route 79.

A pair of registration rollers 84 are located at downstream side of a recording paper transfer direction of the transfer route 79. The pair of registration rollers 84 sandwich the recording paper 6 fed by the transfer roller 83 in the transfer route 79 and feed the recording paper 6 to a second transfer nip at a predetermined timing.

The image former 3 is located at the center of the image forming apparatus 1. Almost at the center of the image former 3, image forming units 10 as process cartridges for each yellow (Y), magenta (M), cyan (C) and black (K) color toner are parallelly located in a horizontal direction to from a tandem image former 20.

Above the four image forming units 10Y, 10C, 10M and 10K, an irradiator 12 irradiating the surface of each charged photoreceptor 11, based on image information read by the scanner 4, to form 1 latent image thereon.

Below the four image forming units 10Y, 10C, 10M and 10K, a transferer 60 is located rotatably holding an intermediate transfer belt 61 while hung around a drive roller 652, a driven roller 651 and a support roller 653. The intermediate transfer belt 61 is a ring-shaped belt member formed of a substrate having a medium resistivity, formed of a heat-resistant material such as polyimide and polyamideimide.

Each of the image forming units has the same composition and Y, C, M and K are omitted when difference of colors do not mean.

The image forming units 10Y, 10C, 10M and 10K have photoreceptors 11Y, 11C, 11M and 11K, respectively. Around each of the photoreceptors 11, a charging roller 21, an image developer 30, a lubricator (unillustrated) and a cleaner 40 are located.

The charging roller 21 charges the surface of the photoreceptor. The image developer 30 develops a latent image formed on the surface of the photoreceptor with a toner to form a toner image thereon. The lubricator applies a lubricant to the surface of the photoreceptor. The cleaner 40 cleans the surface of the photoreceptor with a cleaning blade after the toner image is transferred therefrom.

The charging roller 21 is formed of an electroconductive core metal coated with an elastic layer having a medium resistivity. The charging roller 21 is connected to an unillustrated electric source and applied with a predetermined DC or AC voltage.

The charging roller 21 is formed of an elastic resin roller, and may include an inorganic electroconductive material such as carbon black or an ionic electroconductive material to control electrical resistance thereof.

The charging roller 21 is located with a fine gap from the photoreceptor 11. The fine gap is formed by winding a spacer member having a specific thickness around non-image forming areas at both ends of the charging roller 21 and contacting the surface of the spacer member to the surface of the photoreceptor 11.

The charging roller 21 discharges at a part close to the photoreceptor 11 to charge the photoreceptor 11. When the charging roller 21 does not contact the photoreceptor 11, adherence of an untransferred toner to the charging roller 21 from the photoreceptor 11 is prevented. Therefore, the charging roller 21 is not contaminated with the untransferred toner. The charging roller 21 may contact the photoreceptor 11.

The charging roller 21 includes an unillustrated cleaner roller cleaning the surface of the charging roller 21 while contacting thereto. Even when a toner floating in the apparatus adheres to the surface of the charging roller 21, the cleaner roller cleans the surface of the charging roller 21 so as not be contaminated.

The image developer 30 includes an unillustrated developing sleeve including a magnetic field generator at a position facing the photoreceptor 11.

A stirring and feeding screw mixing a toner placed from an unillustrated toner bottle with a developer and pumping the developer to the developing sleeve while stirring the developer is located below the developing sleeve.

A two-component developer formed of a toner and a magnetic carrier, fed by the developing sleeve is regulated by a regulation member to form a layer having a predetermined thickness, and which is borne by the developing sleeve. The developing sleeve bearing the developer feeds a toner to the photoreceptor 11 while travelling in a same direction at a position facing the photoreceptor 11.

A toner cartridge for each color containing unused toner is detachably installed in a space above the photoreceptor 11. An unillustrated toner feeder such as a mohno pump and an air pump feeds a toner to each of the image developers 30 when necessary. The toner cartridge for black toner consumed much may have larger capacity.

The cleaner 40 is formed of a cleaning blade and a holder holding the blade, and contacts the blade to the photoreceptor 11 with pressure to remove a residual toner therefrom. Further, the cleaner 40 is equipped with a mechanism contacting and separating the cleaning blade to and from the photoreceptor 11, and which is controlled by a controller of the image forming apparatus 1 as desired. The cleaning blade contacts the photoreceptor 11 in a counter direction in respect of traveling direction thereof to remove a toner remaining thereon and additives such as talc, kaolin and calcium carbonate of a recording medium, which adhere thereto. The removed toner is collected by an unillustrated waster toner collection coil and reserved in an unillustrated waster toner container.

Alternatively, the removed toner is collected by a service man or fed to the image developer to be used for development as a recycle toner.

The transferer 60 includes the intermediate transfer belt 61 a toner image is layered on, a first transfer roller 62 transferring and layering the toner image on the photoreceptor 11 to and on the intermediate transfer belt 61 and a second transfer roller 63 transferring the layered toner image onto a recording paper 6.

Further, the transferer 60 includes a support roller 653 on the inside of the intermediate transfer belt 61 at a position facing the second transfer roller 63. In addition, a tension roller 657 pressing the intermediate transfer belt 61 from outside to impart a tension thereto is located on the outside thereof. The first transfer roller 62 first transferring the toner image formed on the photoreceptor 11 onto the intermediate transfer belt 61 is located at a position facing the photoreceptor 11 across the intermediate transfer belt 61.

The first transfer roller 62 is connected to an unillustrated electric source and applied with a predetermined DC or AC voltage.

The voltage applied has a polarity reverse to that of a toner, and the toner image is first transferred when first transfer roller 62 is drawn from the photoreceptor 11 to the intermediate transfer belt 61.

The first transfer roller 62 preferably includes an inorganic electroconductive material such as carbon black or an ionic electroconductive material to control electrical resistance thereof such that the first transfer roller 62 is semiconductive.

Even when the first transfer roller 62 differs in resistivity, transfer efficiency scarcely changes. However, when an image areal ratio differs, the transfer efficiency largely differs and is not stably maintained. This is because a current preferentially runs through a part of a transfer nip where a toner is not present, and a transfer voltage becomes low and an electric field needed to transfer is not sufficiently formed when the image areal ratio is small.

Particularly when the first transfer roller 62 has a low resistivity, the influence of the resistivity of the toner present at a transfer site becomes large. The lower the resistivity of the first transfer roller 62, the larger the influence.

When a constant current control is used, the first transfer roller 62 preferably has a high resistivity. However, when the resistivity is higher than 5×10⁸ [Ω], the current may leak to disturb a toner image. Therefore, the first transfer roller 62 preferably has a resistivity of from 1×10⁵ to 5×10⁸ [Ω].

A current preferentially runs through a part where a toner is not present is not only because of the resistivity. This is partly because a transfer current is likely to run to a larger potential difference since a potential difference between a first transfer voltage applied to the central core metal of the first transfer roller 62 and the photoreceptor 11 at a position where a toner is not developed is larger than a position where the toner is developed.

This occurs in the image forming apparatus 1 in which the toner image has the same polarity as that of the photoreceptor 11 and a toner is developed on a discharged part of the photoreceptor 11 having received imagewise light to form a toner image thereon.

The photoreceptor has a high potential at a part where a toner image is not formed and a low potential at a part where a toner image is formed. However, the transfer potential has a polarity reverse to that of a potential of the photoreceptor, and a difference between a first transfer voltage and potential of the photoreceptor is larger at a part where a toner image is not formed than a part where a toner image is formed.

In this case, the first transfer roller 62 preferably has a resistivity of from 5×10⁷ to 5×10⁸ [Ω].

An optical sensor 90 is located a position facing the drive roller 652 through the intermediate transfer belt 61 with a predetermined gap from an outer surface thereof. The optical sensor 90 is a reflective photosensor emitting light from an unillustrated light emitting element to be reflected on the surface of the intermediate transfer belt 61 or on a toner image thereon and detecting a reflective light amount with an unillustrated light receiving element.

Based on an output voltage value from the optical sensor 90, an unillustrated controller detects a toner image on the intermediate transfer belt 61 or an image density (adherence amount per unit area) thereof.

A toner image layered on the intermediate transfer belt 61 is secondly transferred onto the recording paper 6 at a second transfer part formed by contact between the second transfer roller 63 and the intermediate transfer belt 61. The second transfer roller 63 is connected to an unillustrated electric source as the first transfer roller 62 and applied with a predetermined DC or AC voltage. The voltage applied has a polarity reverse to that of a toner, and the toner image is secondly transferred when the second transfer roller 63 is drawn from the intermediate transfer belt 61 to the recording paper 6.

The second transfer roller 63 is formed of a cylindrical core metal, an elastic layer overlying an outer circumferential surface of the core metal, and a surface layer formed of a resin overlying an outer circumferential surface of the elastic layer.

Specific examples of metals forming the core metal include, but are not limited to, stainless and aluminum. The elastic layer is typically a rubber layer. This is because the second transfer roller 63 is required to have elasticity such that it is deformed to form a second transfer nip. Therefore, the elastic layer preferably has a JIS-A hardness not greater than 70°.

Further, a cleaning blade 22 is used to clean the second transfer roller 63. When the elastic layer is too soft, the cleaning blade 22 unstably contacts the second transfer roller 63, resulting in unsuitable cleaning angle. Therefore, the elastic layer preferably has a JIS-A hardness not less than 40°.

The elastic layer preferably includes a foamed resin imparted with electroconductivity because the second transfer roller 63 transfers a toner image onto a recording paper, and has a thickness of from 2 to 10 mm. Specific examples of materials imparting electroconductivity include, but are not limited to, EPDM or Si rubber in which carbon black is dispersed, NBR having ionic conductivity, and urethane rubber.

Many of the foamed resins used in the elastic layer have high chemical affinity with a toner and large friction coefficient. Therefore, the surface layer the cleaning blade 22 contacts includes a fluorine-containing resin and a resistivity controller because of needing low friction coefficient and releasability.

The second transfer roller 63 rotates contacting the intermediate transfer belt 61, and a small difference in linear speed therebetween influences upon drive of the intermediate transfer belt 61. Therefore, the elastic layer of the second transfer roller 63 is required to have slidability with the intermediate transfer belt 61, and the outermost surface of the surface layer preferably has a friction coefficient not greater than 0.4.

In addition, the intermediate transfer belt 61 includes a belt cleaner 64 cleaning the surface of the intermediate transfer belt 61.

The support roller 653 has a mechanism of contacting and separating itself to and from the intermediate transfer belt 61, and which is controlled by a controller of the image forming apparatus 1 as desired.

A lubricant applicator 67 applying a lubricant to the intermediate transfer belt 61 may be installed when necessary.

The lubricant applicator 67 includes a solid lubricant contained in a fixed case, a brush roller contacting the solid lubricant to scrape the lubricant off and apply it to the intermediate transfer belt 61, and a lubricant application blade leveling off the lubricant applied by the brush roller. The solid lubricant has the shape of a cuboid and is biased to the brush roller by a pressure spring. The solid lubricant is scraped off by the brush roller and consumed. The solid lubricant decreases in thickness as time passes and constantly contacts the brush roller because it is pressurized by the pressure spring. The brush roller applies the scraped lubricant to the surface of the intermediate transfer belt 61 while rotating. A lubricant having the same functions may be installed for the photoreceptor 11.

In this embodiment, an unillustrated lubricant application blade as a lubricant leveler contacts the surface of the intermediate transfer belt 61 at downstream side relative to a position where the lubricant is applied by the brush roller.

The lubricant application blade is formed of an elastic rubber, and has function as a cleaner as well and contacts the intermediate transfer belt 61 in a counter direction in respect of travelling direction thereof.

A dry solid hydrophobic lubricant can be used as the solid lubricant. Besides zinc stearate, metal compounds having a fatty acid group such as stearic acid, oleic acid and palmitic acid can be used. Further, waxes such as candelilla wax, carnauba wax, rice wax, Japan wax, jojoba oil, honey wax and lanoline.

Below the transferer 60, a fixer 70 fixing a toner image on a recording paper thereon is installed.

The recording paper 6 a toner image is transferred on at the second transfer nip is fed to the fixer 70 by a recording paper feed belt 66 hung with tension by tension rollers 65 and 6b.

The fixer 70 is mainly formed of a fixing roller 71 including an unillustrated halogen heater and a pressure roller 72 facing and contacting the fixing roller 71 with pressure.

The fixer 70 is controlled by an unillustrated controller to have optimum fixing conditions according to a printed matter, i.e., whether it is a full-color image or a monochrome image, one-side printing or duplex printing, or a kind of recording medium.

When the duplex printing mode is selected, a switching claw 851 feeds the recording paper 6 an image is fixed on one side thereof to a recording paper reverser 89. Plural rollers and unillustrated guide members in a reverse route 87 reciprocates the recording paper thereon to be turned over. When the recording paper is turned over, a switching claw 852 returns the recording paper 6 to the transfer position again. After an image is transferred and fixed on the backside of the recording paper 6, it is finally discharged by a paper discharge roller 85 on a discharged paper tray 86.

When the recoding paper 6 is one, it is turned over and passed through the reverse route 87 of the recording paper reverser 89. The pair of registration rollers 84 feed the recording paper 6 after an image is formed on one side thereof by the image forming unit 10 to the transfer position where an image is transferred on the recording paper 6. After an image is transferred and fixed on the backside of the recording paper 6, it is finally discharged by a paper discharge roller 85 on a discharged paper tray 86.

When there are plural recording papers 6, a predetermined number thereof on each of which a toner image is formed are contained in a recording paper reverser container 88 in the recording paper reverser 89 once. Next, the recording papers 6 are fed from the recording paper reverser container 88 by the paper feed roller 82 and separated from one by one by the separation roller 81. The recoding paper 6 is fed by the feed roller 83 to the pair of registration rollers 84, and they feed the recording paper 6 after an image is formed on one side thereof by the image forming unit 10 to the transfer position where an image is transferred on the recording paper 6. After an image is transferred and fixed on the backside of the recording paper 6, it is finally discharged by a paper discharge roller 85 on a discharged paper tray 86.

In FIG. 2, the intermediate transfer belt 61 is hung around the drive roller 652 and the driven roller 651.

Below the drive roller 652, between the support roller 653 and the driven roller 651, a tension roller 657 curving the belt from outside to inside is located. The tension roller 657 forms a space below the curving part of the intermediate transfer belt 61. The fixer 70 is located in the space to effectively use spaces in the image forming apparatus in a vertical direction. Thus, a size of the image forming apparatus in a vertical direction is shortened, and the apparatus is downsized.

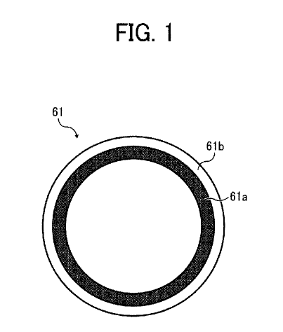

FIG. 1 is a schematic view illustrating a layer composition of an embodiment of the intermediate transfer belt 61 for use in the present invention.

The intermediate transfer belt 61 has a double-layered structure including an inner (base) layer 61a formed of a resin and an outer (surface) layer 61b formed of the same resin overlying the inner (base) layer 61a. The resin is preferably a polyimide resin or a polyamideimide resin having high strength and high elasticity.

The resin includes a filler or an additive regulating electrical resistance, i.e., an electrical resistance regulator such as metal oxides and carbon black.

Specific examples of the metal oxides include, but are not limited to, zinc oxide, tin oxide, titanium oxide, zirconium oxide, aluminum oxide, and silicon oxide. Other examples thereof include products obtained by subjecting the above metal oxide to a surface treatment for improving dispersibility thereof.

Specific examples the carbon black include, but are not limited to, ketjen black, furnace black, acetylene black, thermal black and gas black. They are preferably dispersible in polyimide.

The electrical resistance regulators in this embodiment are not limited to the above. A coating liquid including at least a resin for preparing a seamless belt as the intermediate transfer belt 61 of this embodiment may further include an additive such as a dispersion auxiliary, a reinforcing agent, a lubricant, a heat-transfer agent and an antioxidant.

Next, the polyimide resin used in this embodiment is explained.

Aromatic polyimide is obtained through a polyamic acid (polyimide precursor) produced from a reaction between aromatic polycarboxylic acid anhydrides (or their derivatives) and aromatic diamines.

The aromatic polyimide is insoluble in solvents because of its rigid main chain structure, and does not melt. First, aromatic polycarboxylic acid anhydrides and aromatic diamines are reacted with each other to synthesize a polyimide precursor (polyamic acid). The polyamic acid is heated or chemically dehydrated to obtain cyclized (imidized) polyimide. Aromatic polyimide is obtained by subjecting almost same moles of the following aromatic polycarboxylic acid anhydrides and aromatic diamines to polymerization reaction in an organic polar solvent:

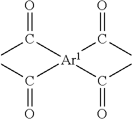

wherein Ar¹ is a tetravalent aromatic residue containing at least one aromatic ring.

Thus, the polyimide precursor (polyamic acid) is obtained, and then the polyamic acid is dehydrated to be cyclized and imidized. Methods of preparing the polyamic acid are specifically explained.

Specific examples of the organic polar solvent used in the polymerization reaction to prepare the polyamic acid include, but are not limited to, a sulfoxide-based solvent such as dimethylsulfoxide, and diethyl sulfoxide; a formamide-based solvent such as N,N-dimethylformamide, and N,N-dimethylformamide; an acetoamide-based solvent such as N,N-dimethylacetamide, and N,N-diethylacetamide; a pyrrolidone-based solvent such as N-methyl-2-pyrrolidone, and N-vinyl-2-pyrrolidone; and a phenol-based solvent such as phenol, o-, m-, or p-cresol, xylenol, halogenated phenol, and catechol; an ether-based solvent such as tetrahydrofuran, dioxane, and dioxolane; an alcohol-based solvent such as methanol, ethanol, and butanol; a cellosolve-based solvent such as butyl cellosolve; hexamethylphosphoramide; and γ-butyrolactone. These can be used alone or in combination.

The organic polar solvents are not particularly limited if they dissolve the polyamic acid, but γ-butyrolactone and N-methyl-2-pyrrolidone are preferably used.

An example of preparing the polyimide precursor, first, one or more diamine is dissolved in the organic solvent, or dispersed therein to form a slurry in an atmosphere of inactive gas such as argon or nitrogen.

To the resultant solution, an aromatic polycarboxylic anhydride (or a derivative thereof) is added (which may be in the state of a solid, a solution being dissolved in an organic solvent, or a slurry) to thereby proceed to a ring-opening polyaddition reaction with generation of heat. As a result, the solution suddenly increases its viscosity, to thereby prepare a high-molecular-weight polyamic acid solution. The reaction temperature is preferably from −20 to 100° C., and more preferably in the range of −20 to 60° C. The reaction time is about from 30 min to 12 hrs.

The example described above is one example. Conversely to the order of addition above, first, aromatic tetracarboxylic dianhydride or a derivative thereof is dissolved or dispersed in an organic solvent in advance, and to the resultant solution, the aromatic diamine(diamine) may be added. The diamine may be added in the state of a solid, or a solution prepared by dissolving the aromatic diamine compound in an organic solvent, or a slurry. Namely, the order for adding the aromatic tetracarboxylic dianhydride and the diamine is not limited. Further, aromatic tetracarboxylic dianhydride and the diamine compound may be simultaneously added to the organic polar solvent to proceed to a reaction.

Specific examples of the aromatic polycarboxylic anhydride include, but are not limited to, pyromellitic acid dianhydride, 4,4′-oxydiphthalic dianhydride, ethylene tetracarboxylic dianhydride, cyclopentane tetracarboxylic dianhydride, 3,3′,4,4′-benzophenonetetracarboxylic dianhydride, 2,2′,3,3′-benzophenonetetracarboxylic dianhydride, 3,3′,4,4′-biphenyltetracarboxylic dianhydride, 2,2′,3,3′-biphenyltetracarboxylic dianhydride, 2,2-bis(2,3-dicarboxyphenyl)propane dianhydride, bis(3,4-dicarboxyphenyl) ether dianhydride, bis(3,4-dicarboxyphenyl)sulfone dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 2,2-bis(3,4-dicarboxyphenyl)-1,1,1,3,3,3-hexafluoropropane dianhydride, 2,3,6,7-naphthalenetetracarboxylic dianhydride, 1,4,5,8-naphthalenetetracarboxylic dianhydride, 1,2,5,6-naphthalenetetracarboxylic dianhydride, 1,2,3,4-benzenetetracarboxylic dianhydride, 3,4,9,10-perylenetetracarboxylic dianhydride, 2,3,6,7-anthracenetetracarboxylic dianhydride, and 1,2,7,8-phenanthreneteracarboxylic dianhydride. These can be used alone or in combination.

Specific examples of the aromatic diamine compound include, but are not limited to, 4,4′-diaminodiphenylether, 3,3′-diaminodiphenylether, 3,4′-diaminodiphenylether, m-phenylene diamine, o-phenylene diamine, p-phenylene diamine, m-aminobenzyl amine, p-aminobenzyl amine, bis(3-aminophenyl)sulfide, (3-aminophenyl)(4-aminophenyl)sulfide, bis(4-aminophenyl)sulfide, (3-aminophenyl)(4-aminophenyl)sulfoxide, bis(3-aminophenyl)sulfone, (3-aminophenyl)(4-aminophenyl)sulfone, bis(4-aminophenyl)sulfone, 3,3′-diaminobenzophenone, 3,4′-diaminobenzophenone, 4,4′-diaminobenzophenone, 3,3′-diaminodiphenyl methane, 3,4′-diaminodiphenyl methane, 4,4′-diaminodiphenyl methane, bis[4-(3-aminophenoxy)phenyl]methane, bis[4-(4-aminophenoxy)phenyl]methane, 1,1-bis[4-(3-aminophenoxy)phenyl]ethane, 1,1-bis[4-(4-aminophenoxy)phenyl]-ethane, 1,2-bis[4-(3-aminophenoxy)phenyl]ethane, 1,2-bis[4-(4-aminophenoxy)phenyl]ethane, 2,2-bis[4-(3-aminophenoxy)phenyl]propane, 2,2-bis[4-(4-aminophenoxy)phenyl]propane, 2,2-bis[4-(3-aminophenoxy)phenyl]butane, 2,2-bis[3-(3-aminophenoxy)phenyl]-1,1,1,3,3,3-hexafluoropropane, 2,2-bis[4-(4-aminophenoxy)phenyl]-1,1,1,3,3,3-hexafluoropropane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]sulfoxide, bis[4-(4-aminophenoxy)phenyl]sulfoxide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 1,4-bis[4-(3-aminophenoxy)benzoyl]benzene, 1,3-bis[4-(3-aminophenoxy)benzoyl]benzene, 4,4′-bis[3-(4-aminophenoxy)benzoyl]diphenyl ether, 4,4′-bis[3-(3-aminophenoxy)benzoyl]diphenyl ether, 4,4′-bis[4-(4-amino-α,α,-dimethylbenzyl)phenoxy]benzophenone, 4,4′-bis[4-(4-amino-α,α-dimethylbenzyl)phenoxy]diphenylsulfone, bis[4-{4-(4-aminophenoxy)phenoxy}phenyl]sulfone, 1,4-bis[4-(4-aminophenoxy)phenoxy]-α,α-dimethylbenzyl]benzene, and 1,3-bis[4-(4-aminophenoxy)-α,α-dimethylbenzyl]benzene. These can be used alone or in combination.

In the manner as described above, an equimolar aromatic polycarboxylic anhydride or a derivative thereof, and an equimolar aromatic diamine compound are subjected to a polymerization reaction in an organic polar solvent, to thereby prepare a polyamic acid (polyimide precursor) solution in the state that polyamic acid is uniformly dissolved in the organic polar solvent.

The polyamic acid can be imidized by a (1) heating method, or a (2) chemical method. The (1) heating method is a method for transforming (imidizing) the polyamic acid to polyimide by heating the polyamic acid to 200° C. to 350° C., and is a simple and practical method for attaining polyimide (a polyimide resin). The (2) chemical method is a method in which after reacting the polyamic acid with a cyclodehydration reagent (e.g., a mixture of carboxylic anhydride and tertiary amine), the resultant is heated to thereby completely imidize the polyamide acid, and a complicated and costly method compared to the (1) heating method. From this reason, generally, the (1) heating method is commonly used.

The polyimide is preferably heated at not less than a glass transition to be imidized such that the polyimide exert its original performance. Marketed polyimides can be used in this embodiment such as general-purpose polyamides from Du Pont-Toray Co., Ltd., Ube Industries, Ltd., New Japan Chemical Co., Ltd., JSR, Unitika Ltd., IST, Hitachi Chemical Co., Ltd., etc.

The polyamideimide is a resin having a rigid imide group and a flexibility-imparting amide group in its molecular skeleton. Known polyamideimide can be used in this embodiment.

Typically, the following methods of synthesizing polyamideimide resins are known.

(a) Japanese published examined application No. JP-S42-15637-B discloses an acid chloride method of reacting a derivative halide of tricarboxylic acid having an acid anhydride group, typified by a chloride compound of the derivative, and diamine in a solvent.

(b) Japanese published examined application No. JP-S44-19274-B discloses an isocyanate method of reacting a trivalent including an acid anhydride group and a carboxylic acid having, and an aromatic isocyanate in a solvent.

Specific examples of the derivative halide of tricarboxylic acid having an acid anhydride group include compounds having the following formulae:

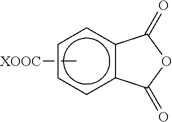

wherein X represents a halogen atom, and

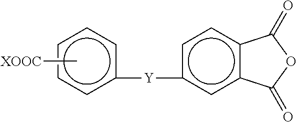

wherein X represents a halogen atom; and Y represents —CH₂—, —CO—, —SO₂— or —O—.

In the above formulae, the halogen atom is preferably chloride. Specific examples of the derivative include, but are not limited to, acid chlorides of polycarboxylic acid such as terephthalic acid, isophthalic acid, 4,4′-biphenyldicarboxylic acid, 4,4′-biphenyletherdicarboxylic acid, 4,4′-biphenylsulfonedicarboxylic acid, 4,4′-benzophenonedicarboxylic acid, pyromellitic acid, trimellitic acid, 3,3′-4,4′-benzophenonetetracarboxylic acid, 3,3′-4,4′-biphenylsulfonetetracarboxylic acid, 3,3′-4,4′-biphenyltetracarboxylic acid, adipic acid, sebacic acid, maleic acid, fumaric acid, dimeric acid, stilbene dicarboxylic acid, 1,4-cyclohexanedicarboxylic acid, and 1,4-cyclohexanedicarboxylic acid.

Specific examples of the diamine include, but are not limited to, aromatic diamines, aliphatic diamines and alicyclic diamines. The aromatic diamines are preferably used.

Specific examples of the aromatic diamines include, but are not limited to, m-phenylene diamine, p-phenylene diamine, oxy dianiline, methylene diamine, hexafluoroisoproylidene diamine, diamino-m-xylilene, diamino-p-xylilene, 1,4-naphthalene diamine, 1,5-naphthalene diamine, 2,6-naphthalene diamine, 2,7-naphthalene diamine, 2,2′bis-(4-aminophenyl)propane, 2,2′-bis-(4-aminophenyl)hexafluoropropane, 4,4′-diaminodiphenylsulfone, 4,4′-diaminodiphenylether, 3,3′-diaminodiphenylsulfone, 3,3′-diaminodiphenylether, 3,4′-diaminobiphenyl, 4,4′-diaminobenzophenone, 3,4′-diaminodiphenylether, isopropylidene dianiline, 3,3′-diaminobenzophenone, o-tolidine, 2,4-trilenediamine, 1,3-bis-(3-aminophenoxy)benzene, 1,4-bis(3-aminophenoxy)benzene, 1,3-bis-(4-aminophenoxy)benzene, 2,2-bis[4-(4-aminophenoxy)phenyl]propane, bis[4-(4-aminophenoxy)phenyl]sulfone, bis[4-(3-aminophenoxy)phenyl]sulfone, 4,4′-bis-(4-aminophenoxy)biphenyl, 2,2-bis[4-(4-aminophenoxy)phenyl]hexafluoropropane, 4,4′-diaminodiphenylsulfide, and 3,3′-diaminodiphenylsulfide,

Silicone-modified polyamideimide can be obtained when siloxane compounds having an amino group at both ends as diamine are used. Specific examples of the siloxane compounds having an amino group at both ends as diamine include 1,3-bis(3-aminopropyl)-1,1,3,3-tetramethyldisiloxane, α, Ω-bis-(3-aminopropyl)polydimethylsiloxane, 1,3-bis(3-aminophenoxymethyl)-1,1,3,3-tetramethyldisiloxane, α,Ω-bis-(3-aminophenoxymethyl)polydimethylsiloxane, 1,3-bis(2-(3-aminophenoxy)ethyl)-1,1,3,3-tetramethyldisiloxane, α,Ω-bis-(2-(3-aminophenoxy)ethyl))polydimethylsiloxane, 1,3-bis(3-(3-aminophenoxy)propyl)-1,1,3,3-tetramethyldisiloxane, and α, Ω-bis-(3-(3-aminophenoxy)propyllpolydimethylsiloxane.

To obtain polyamideimide in the embodiment by the acid chloride method, as the polyimide resin is prepared, a derivative halide of tricarboxylic acid having an acid anhydride group and diamine are dissolved in an organic polar solvent, and reacted therein at a low temperature of form 0 to 30° C. to prepare a polyamideimide precursor (polyamide-amic acid).

Specific examples of the organic polar solvent include, but are not limited to, a sulfoxide-based solvent such as dimethylsulfoxide, and diethyl sulfoxide; a formamide-based solvent such as N,N-dimethylfomamide, and N,N-diethylformamide; an acetoamide-based solvent such as N,N-dimethylacetamide, and N,N-diethylacetoamide; a pyrrolidone-based solvent such as N-methyl-2-pyrrolidone, and N-vinyl-2-pyrrolidone; and a phenol-based solvent such as phenol, o-, m-, or p-cresol, xylenol, halogenated phenol, and catechol; an ether-based solvent such as tetrahydrofuran, dioxane, and dioxolane; an alcohol-based solvent such as methanol, ethanol, and butanol; a cellosolve-based solvent such as butyl cellosolve; hexamethylphosphoramide; and γ-butyrolactone. These can be used alone or in combination.

The organic polar solvents are not particularly limited if they dissolve the polyamideimide precursor, but γ-butyrolactone and N-methyl-2-pyrrolidone are preferably used.

The polyamideimide is typically used alone, but can be combined with compatible polyamideimide or modified groups such as silicone and fluorine. Marketed polyamideimide varnish from Hitachi Chemical Co., Toyobo Co., Ltd., and Arakawa Chemical Industries, Ltd can also be used.

The other components are appropriately selected depending on the intended purpose without any limitation, and examples thereof include an electrical resistance regulator, an ion conductive agent, a dispersion auxiliary, a reinforcing agent, a lubricant, a heat-transfer agent and an antioxidant.

The intermediate transfer belt 61 in the image forming apparatus of the embodiment has a double-layered structure formed of the inner layer 61a and the outer layer 61b each formed of a same resin to prevent the belt from curling inside or outside and improve adhesiveness between the inner layer 61a and the outer layer 61b.

Examples of the electrical resistance regulator include metal oxide, carbon black, an ion conductive agent, and an electric conductive polymer material. Examples of the metal oxide include zinc oxide, tin oxide, titanium oxide, zirconium oxide, aluminum oxide, and silicon oxide. Other examples thereof include products obtained by subjecting the above metal oxide to a surface treatment for improving dispersibility thereof. Among these, carbon black is preferably used because it is easy to disperse and difficult to deteriorate in strength.

Examples of the carbon black include ketjen black, furnace black, acetylene black, thermal black and gas black.

Examples of the ion conductive agent include a tetra alkyl ammonium salt, a trialkylbenzyl ammonium salt, an alkylsulfonic acid salt, an alkylbenzenesulfonic acid salt, alkyl sulfate, glycerin fatty acid ester, sorbitan fatty acid ester, polyoxyethylenealkylamine, ester of polyoxyethylene aliphatic alcohol, alkyl betaine, and lithium perchlorate. Examples of electric conductive polymer material include polyaniline, polythiophene, and polypyrrole. These can be used alone or in combination.

The electrical resistance regulators in this embodiment are not limited to the above. A coating liquid including at least a resin for preparing a seamless belt of this embodiment may further include an additive such as a dispersion auxiliary, a reinforcing agent, a lubricant, a heat-transfer agent and an antioxidant.

Each of the inner layer 61a and the outer layer 61b preferably includes a similar amount of the electrical resistance regulator such as carbon black such that they have similar contraction when heated. The outer layer 61b preferably includes the electrical resistance regulator in an amount of ±5% by weight of that in the inner layer 61a to prevent the belt from curling.

When a seamless belt is used as the intermediate transfer belt 61, carbon black is included in its layers such that the electric resistance thereof is 1×10⁸Ω/□ to 1×10¹⁵Ω/□ in the surface resistance when 500 V is applied thereto, and 1×10⁸ Ω·cm to 1×10¹⁴ Ω·cm in the volume resistance when 100 V is applied thereto. However, in terms of mechanical strength, carbon black is included in the layers in such an amount as they are not fragile and easily cracked.

Namely, a coating liquid including the resin (a polyimide resin precursor or a polyamideimide resin precursor) and the electrical resistance regulator in suitable amounts, respectively is preferably used to prepare a seamless belt having a good balance between electrical properties (surface resistivity and volume resistivity) and mechanical strength.

When the electrical resistance is the carbon black, the content thereof is preferably from 10 to 25% by weight, and more preferably from 15 to 20% by weight. When the electrical resistance is the metal oxide, the content thereof is preferably from 1 to 50% by weight, more preferably from 10 to 30% by weight. When the content is too low, the resistance is difficult to have uniformity and largely varies relative to arbitrary potentials. When too much, the intermediate transfer belt 61 deteriorates in mechanical strength for practical use.

The average thickness of the inner layer 61a and the outer layer 61b is appropriately selected depending on the intended purpose without any limitation, but the outer layer 61b preferably has a thickness of from 40 to 60% based on total thickness of the belt because of preventing the belt from curling and adhesiveness of the inner layer 61a and the outer layer 61b, and the belt preferably has a thickness of from 40 to 150 μm, and more preferably from 50 to 90 μm.

When less than 40 μm, ends of the belt are likely to cut. When greater than 150 μm, the intermediate transfer belt 61 is likely to crack due to a curve formed between the belt and a roller.

The average thickness is an average value of the values of the thickness measured at arbitrarily selected 10 spots. The thickness can be measured by typical needle-indicating or eddy-current thickness meters, for example, by an electric micrometer manufactured by Anritsu Corporation. The thickness of each of the inner layer 61a and the outer layer 61b can be measured by measuring a cross-section at an arbitrary point of the belt by a scanning electron microscope (SEM).

Methods of forming the inner layer 61a and the outer layer 61b of the intermediate transfer belt 61 are appropriately selected depending on the intended purpose without any limitation. Examples thereof include a method containing: preparing a coating liquid in which the aforementioned other components such as the electrical resistance regulator optionally dispersed in the polyimide precursor solution (polyamic acid solution); applying the coating liquid onto a substrate; and transforming (imdizing) polyamic acid, which is polyimide precursor, into polyimide, as well as forming the coating liquid into a layer by a processing, such as heating.

The substrate is appropriately selected depending on the intended purpose without any limitation, and examples thereof include a cylindrical metal mold.

An example of preparing the intermediate transfer belt 61 is specifically explained. An outer surface coating method preferably used in the embodiment is explained.

A coating liquid containing polyimide precursor is applied onto a cylindrical mold, such as a cylindrical metal mold, by a liquid supplying device, such as a nozzle and a dispenser, while slowly rotating the cylindrical mold, so as to uniformly coat the outer surface of the cylindrical mold with the coating liquid, to thereby perform flow casting (forming a coating film). Thereafter, the rotational speed is increased to a predetermined speed. Once the rotational speed reaches the predetermined speed, the rotational speed is maintained constant, and the rotation is continued for a predetermined period. Then, the temperature is gradually elevated while rotating the cylindrical mold, to thereby evaporate the solvent in the coating film at the temperature of 80° C. to 150° C. It is preferred that the vapor (e.g., the evaporated solvent) in the atmosphere be efficiently circulated and removed.

Once a self-supporting film is formed, the temperature of the furnace is increased stepwise, and eventually a high temperature heat treatment (baking) is performed at the temperature ranging from about 200° C. to about 350° C., to thereby imidize the polyimide precursor to some extent to form the inner layer 61a. When the polyimide precursor is completely imidized, adhesiveness with polyimide in the outer layer 61b becomes poor. After fully cooled, an outer layer coating liquid is coated and dried as the inner layer coating liquid, and then the polyimide precursor sufficiently imidized. The inner layer and the outer layer are applied with different heat energies such that even the same resin has a difference in contraction when imidized to prevent the inner and outer layers form curling.

The metal mold is not dried with hot air applied from outside by marketed driers or heating furnaces, and preferably heated from the inside. Any heaters may be used, and specifically a halogen heater and an IH heater can be used.

When an outer surface of the belt is coated and the metal mold is heated from the inside (backside), a curl angle from the surface of the belt is larger than a curl angle from the backside of the belt, i.e., 85° or more.

The inner layer 61a and the outer layer 61b are preferably heated from the inside of the metal mold to be dried. They are preferably heated from the inside of the metal mold as well when coated inside. The inside-coated belt is likely to separate from the metal mold when heated to perform polyimide contraction, and tends to curl more than the outside-coated belt.

This is because the surface is imidized but not imidized well inside when they are heated from outside of the metal mold, and the resultant belt tends to curl more.

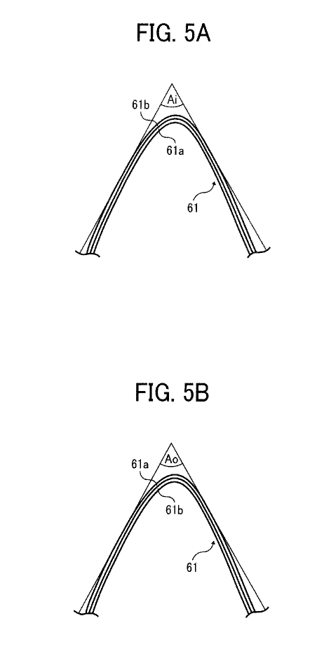

Next, a method of measuring a curl angle of the intermediate transfer belt 61 is explained. FIG. 4 is a schematic view illustrating a curl applicator 50 curling the belt. FIGS. 5A and 5B are schematic views for explaining a curl angle, in which a sample 52 placed on a horizontal table for 60 min is viewed from directly above.

A cut sample 125 mm (circumferential direction)×15 mm (axial direction) is hung on a metallic bar 51 having a diameter of 14 mm as FIG. 4 shows, one side of the sample is fixed with a clip 53 and a weight 54 weighing 2.25 N is hung on the other side. Then, the sample is left for 14 days in an environment of 45° C. and 90% RH.

Then, the clip 53 and the weight 54 are taken off from the sample 52, and the sample is placed on the horizontal table with an end in the circumferential direction down and left for 60 min in an environment of 23° C. and 50% RH. Then, an angle of a curl on the sample 52 is measured as FIGS. 5A and 5B show.

A curl angle Ai of the backside (inner layer 61a) of the belt is a curl angle when the backside (inner layer side) of the intermediate transfer belt 61 is wound around the metallic bar 51 while contacting thereto. A curl angle Ao of the surface (outer layer 61b) of the belt is a curl angle when the surface (outer layer side) of the intermediate transfer belt 61 is wound around the metallic bar 51 while contacting thereto.

The curl angle Ai and the curl angle Ao are preferably not less than 85° for practical use. When less than 85°, the belt waves, and the belt is damaged and may be cracked or broken in the worst case.

Further, a transfer pressure changes and transfer amount becomes less at the curled part, resulting in uneven image density.

When the belt has a single-layered structure, either the curl angle Ai or the curl angle Ao can be not less than 85°, and it is difficult for them both to be not less than 85°.

In an image forming apparatus without a pressure member (tension roller), the intermediate transfer belt 61 only curves from inside to outside. Therefore, there is no problem in practical use if only the curl angle Ai is not less than 85°.

However, in the image forming apparatus of the embodiment, the intermediate transfer belt 61 not only curves from inside to outside, but also from outside to inside. Therefore, not only the curl to inside (backside) but also the curl to outside (surface side) need to be considered.

When a curled part enters the first transfer nip, a contact pressure changes. The image density is high at a part where the contact pressure is high and low at a part where the contact pressure is low. As a result, the image has uneven image density in a travel direction of the belt, i.e., lateral band unevenness.

Not only the intermediate transfer belt 61 but also other belts in an image forming apparatus have problems when curled. For example, when a curled recording paper feed belt feeds the recording paper 6 to the second transfer position bearing the paper on the curled part, the resultant image may have the same uneven image density due to changes of contact pressure.

Japanese published unexamined application No. JP-2002-182488-A discloses a method of including a fibrous conductive agent and an inorganic filler in a polyimide resin to improve creep (curl). However, the inorganic filler is difficult to disperse in polyimide, uniformity of image density is insufficient. Further, the conductive agent reduces adhesiveness of the resin layer and the layer is likely to peel off. Although creep is improved in an environment of normal temperature, curl remains same in an environment of high temperature and high humidity.

Japanese published unexamined application No. JP-2004-126068-A discloses a method of including a flaky particulate powder in a polyimide resin to improve creep. However, the flaky particles are easy to aggregate and the resultant images do not have sufficient quality. Further, the method does not prevent the belt from curing in an environment of high temperature and high humidity.

A residual solvent largely influences upon properties of the belt. When too much, the belt absorbs moisture in an environment of high temperature and high humidity, and changes in sizes and lowers in resistivity, resulting in variation of image density and defective running. When too little, the belt deteriorates in flexibility, resulting in crack and break thereof. Therefore, the residual solvent is preferably from 5 to 2,000 ppm at an arbitrary point when the layers are layered.

An amount of the residual solvent is controlled by drying temperature and time. When a coating liquid is coated on the inner surface of the metal mold, a solvent vapor is likely to remain when heated and the residual solvent in the belt is likely to increase. Therefore, the coating liquid is preferably coated on the outer surface of the metal mold.

When the belt has a single-layered structure, the residual solvent needs to be 3 ppm or less such that the curl angles Ai and Ao are both not less than 85°. However, in this case, the drying time is so long that the cost largely increases. Further, the belt deteriorates in flexibility and is likely to crack. Namely, the belt does not have sufficient durability for practical use.

Methods of measuring the residual solvent in the belt include analyzing a part randomly cut out from the intermediate transfer belt 61 by thermal extraction gas chromatograph mass analysis (GC-MS) method. Marketed products of the GC-MS apparatus include GCMS-QP2010 from Shimadzu Corp.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

An amount of the residual solvent N-methyl-2-pyrrolidone (NMP) in the seamless belt was determined by the following formula, using the method of analyzing a part randomly cut out from the belt by thermal extraction gas chromatograph mass analyzer GCMS-QP2010 from Shimadzu Corp.

Measured Amount of N-methyl-2-pyrrolidone (μg)/Weight of Belt Sample (g)

A curl angle was measured by hanging a cut sample 125 mm (circumferential direction)×15 mm (axial direction) on a metallic bar 51 having a diameter of 14 mm as FIG. 4 shows, one side of the sample is fixed with a clip 53 and a weight 54 weighing 2.25 N was hung on the other side. Then, the sample was left for 14 days in an environment of 45° C. and 90% RH. Then, the clip 53 and the weight 54 were taken off from the sample 52, and the sample was placed on a horizontal table with an end in the circumferential direction down and left for 60 min in an environment of 25° C. and 60% RH. Then, an angle of a curl on the belt along the contact surface of the metallic bar 51 was measured as FIGS. 5A and 5B show.

A curl angle Ai of the backside (inner layer 61a) of the belt was a curl angle when the backside (inner layer side) of the intermediate transfer belt 61 was wound around the metallic bar 51 while contacting thereto. A curl angle Ao of the surface (outer layer 61b) of the belt was a curl angle when the surface (outer layer side) of the intermediate transfer belt 61 was wound around the metallic bar 51 while contacting thereto.

### Example 1

### Preparation of Polyimide Coating Liquid A

In a mixture including U-varnish A and U-varnish S from Ube Industries, Ltd. at a solid content ratio of 50/50, which are polyimide varnishes including a polyimide resin precursor as a main component, a dispersion including N-methyl-2-pyrrolidone and carbon black (Special Black 4 from Evonik Degussa GmbH) dispersed by beads mill therein was mixed and stirred such that the content of the carbon black was 17% by weight based on total weight of the solid contents to prepare a polyimide coating liquid A.

### (Preparation of Seamless Belt A)

The polyimide coating liquid A was uniformly coated by a dispenser on a blasted (roughened) outer surface of a metallic cylindrical mold having an outer diameter of 375 mm and a length of 340 mm while rotated at 50 rpm.

After the polyimide coating liquid A was uniformly coated, the cylindrical mold was placed in a drier while rotated at 100 rpm. A halogen heater was placed in the center of the metallic mold and the metallic mold was gradually heated up to have a temperature of 110° C. for 60 min.

Further, the metallic mold was heated up to have a temperature of 250° C. for 30 min, and then the rotation thereof was stopped. Then, the cylindrical mold a film was formed on was gradually cooled and taken out from the drier.

Next, the polyimide coating liquid A was uniformly coated by a dispenser on the cylindrical mold while rotated at 50 rpm.

After the polyimide coating liquid A was uniformly coated, the cylindrical mold was placed in a drier while rotated at 100 rpm. A halogen heater was placed in the center of the metallic mold and the metallic mold was gradually heated up to have a temperature of 110° C. for 60 min.

Further, the metallic mold was heated (burned) up to have a temperature of 340° C. for 60 min such that the polyimide coating liquid A was imidized. Then, the metallic mold was gradually cooled and taken out to prepare a seamless belt A.

### Example 2

The procedure for preparation of the seamless belt in Example 1 was repeated except that the drier did not heat the metallic mold from the inside thereof with a halogen heater but generated and circulate hot air from outside of the metallic mold to prepare a seamless belt B.

### Example 3

The procedure for preparation of the seamless belt in Example 1 was repeated except for changing the thickness of the outer layer and the inner layer to prepare a seamless belt C.

### Example 4

The procedure for preparation of the seamless belt in Example 1 was repeated except for changing the thickness of the outer layer and the inner layer to prepare a seamless belt D.

### Example 5

The procedure for preparation of the seamless belt in Example 1 was repeated except for changing the thickness of the outer layer and the inner layer to prepare a seamless belt E.

### Example 6

The procedure for preparation of the seamless belt in Example 1 was repeated except for changing the thickness of the outer layer and the inner layer to prepare a seamless belt F.

### Example 7

The procedure for preparation of the seamless belt in Example 1 was repeated except for burning the outer layer at 340° C. for 120 min to prepare a seamless belt G.

### Example 8

The procedure for preparation of the seamless belt in Example 1 was repeated except for burning the outer layer at 300° C. for 30 min to prepare a seamless belt H.

### Example 9

The polyimide coating liquid A was uniformly coated on a mirrored inner surface treated with a release agent of a metallic cylindrical mold having an outer diameter of 375 mm and a length of 340 mm while rotated at 50 rpm.

After the polyimide coating liquid A was uniformly coated, the cylindrical mold was placed in a drier generating and circulating hot air from outside of the metallic mold while rotated at 100 rpm, and was gradually heated up to have a temperature of 110° C. for 60 min.

Further, the metallic mold was heated up to have a temperature of 250° C. for 30 min, and then the rotation thereof was stopped. Then, the cylindrical mold a film was formed on was gradually cooled and taken out from the drier.

Next, the polyimide coating liquid A was uniformly coated by a dispenser on the cylindrical mold while rotated at 50 rpm.

After the polyimide coating liquid A was uniformly coated, the cylindrical mold was placed in a drier while rotated at 100 rpm. A halogen heater was placed in the center of the metallic mold and the metallic mold was gradually heated up to have a temperature of 110° C. for 60 min.

Further, the metallic mold was heated (burned) up to have a temperature of 340° C. for 60 min. Then, the metallic mold was gradually cooled and taken out to prepare a seamless belt I.

### Example 10

In Vylomax HR-16NN from Toyobo Co., Ltd, which is polyamideimide varnish including a polyamideimide resin precursor as a main component, a dispersion including N-methyl-2-pyrrolidone and carbon black (MA77 from Mitsubishi Chemical Corp.) dispersed by beads mill therein was mixed and stirred such that the content of the carbon black was 23% by weight based on total weight of the solid contents to prepare a polyamideimide coating liquid.

The polyamideimide coating liquid was uniformly coated by a dispenser on a blasted (roughened) outer surface of a metallic cylindrical mold having an outer diameter of 375 mm and a length of 340 mm while rotated at 50 rpm.

After the polyamideimide coating liquid was uniformly coated, the cylindrical mold was placed in a drier while rotated at 100 rpm. A halogen heater was placed in the center of the metallic mold and the metallic mold was gradually heated up to have a temperature of 110° C. for 60 min.

Further, the metallic mold was heated up to have a temperature of 190° C. for 30 min, and then the rotation thereof was stopped. Then, the cylindrical mold a film was formed on was gradually cooled and taken out from the drier.

Next, the polyamideimide coating liquid was uniformly coated by a dispenser on the cylindrical mold while rotated at 50 rpm.

After the polyamideimide coating liquid was uniformly coated, the cylindrical mold was placed in a drier while rotated at 100 rpm. A halogen heater was placed in the center of the metallic mold and the metallic mold was gradually heated up to have a temperature of 110° C. for 60 min.

Further, the metallic mold was heated (burned) up to have a temperature of 260° C. for 60 min such that the polyimide coating liquid A was imidized. Then, the metallic mold was gradually cooled and taken out to prepare a seamless belt J.

### Comparative Example 1

The procedure for preparation of the seamless belt in Example 1 was repeated except for not forming the inner layer to prepare a single-layered seamless belt K having a thickness of 60 μm.

### Comparative Example 2

The procedure for preparation of the seamless belt in Comparative Example 1 was repeated except for burning the layer at 370° C. for 150 min to prepare a seamless belt L.

### Comparative Example 3

The procedure for preparation of the seamless belt in Example 9 was repeated except for not forming the inner layer to prepare a single-layered seamless belt M having a thickness of 60 μm.

Properties of the Seamless Belts A to M are Shown in Tables 1-1 to 1-2

TABLE 1-1

| | Seamless Belt | Base Resin | Coating Method | Heating Method |
|---|---|---|---|---|
| Example 1 | A | Polyimide | Outer Surface | Inner Surface |
| Example 2 | B | Polyimide | Outer Surface | Outer Surface |
| Example 3 | C | Polyimide | Outer Surface | Inner Surface |
| Example 4 | D | Polyimide | Outer Surface | Inner Surface |
| Example 5 | E | Polyimide | Outer Surface | Inner Surface |
| Example 6 | F | Polyimide | Outer Surface | Inner Surface |
| Example 7 | G | Polyimide | Outer Surface | Inner Surface |
| Example 8 | H | Polyimide | Outer Surface | Inner Surface |
| Example 9 | I | Polyimide | Inner Surface | Outer Surface |
| Example 10 | J | Polyamideimide | Outer Surface | Inner Surface |
| Comparative | K | Polyimide | Outer Surface | Inner Surface |
| Example 1 | | | | |
| Comparative | L | Polyimide | Outer Surface | Inner Surface |
| Example 2 | | | | |
| Comparative | M | Polyamideimide | Outer Surface | Inner Surface |
| Example 3 | | | | |

TABLE 1-2

| | Thickness [μm] | | | | |
|---|---|---|---|---|---|
| | | Outer | Curl Angle [°] | | Residual |
| | Inner Layer | Layer | Ai | Ao | NMP [ppm] |
| Example 1 | 30 | 30 | 115 | 137 | 20 |
| Example 2 | 32 | 33 | 85 | 100 | 94 |
| Example 3 | 50 | 40 | 103 | 129 | 1678 |
| Example 4 | 50 | 20 | 95 | 120 | 237 |
| Example 5 | 30 | 40 | 102 | 124 | 560 |
| Example 6 | 30 | 50 | 94 | 117 | 677 |
| Example 7 | 27 | 28 | 117 | 140 | 4 |
| Example 8 | 36 | 39 | 86 | 94 | 2356 |
| Example 9 | 30 | 30 | 88 | 104 | 1477 |
| Example 10 | 30 | 30 | 87 | 101 | 1884 |

| | | | | |
|---|---|---|---|---|
| Comparative | 60 (single-layered) | 70 | 91 | 120 |
| Example 1 | | | | |
| Comparative | 60 (single-layered) | 89 | 112 | 1 |
| Example 2 | | | | |
| Comparative | 60 (single-layered) | 50 | 66 | 2553 |
| Example 3 | | | | |

The seamless belt of each Example had an Ai and an Ao not less than 85°, respectively.

When the inner layer 61a is formed before the outer layer 61b, the inner layer 61a is dried twice in the process of forming the inner layer 61a and the outer layer 61b. The outer layer 61b is dried once in the process of forming the same. When the outer layer 61b is formed before the inner layer 61a, the outer layer 61b is dried twice in the process of forming the outer layer 61b and the inner layer 61a. The inner layer 61a is dried once in the process of forming the same.

Therefore, the inner layer 61a and the outer layer 61b have different properties each other even formed of a same resin. It is thought a difference of heat expansion coefficient therebetween generates a force offsetting curls to inside and outside of the belt, resulting in reduction thereof.

Each of the seamless belts A to M was installed in the image forming apparatus in FIG. 2. After left in an environment of 40° C. and 85% RH for 24 hrs, 1,000 cyan and magenta two-color solid images were produced on plain papers TYPE 6200 from Ricoh Company, Ltd. thereby. This was one cycle and repeated for plural times to visually observe image quality.

Excellent: No uneven image density sample

Good: 1 to 5 pieces of uneven image density samples

Fair: 6 to 10 pieces of uneven image density samples

Poor: 11 or more pieces of uneven image density samples

In addition, after left in an environment of 40° C. and 85% RH for 24 hrs, 100,000 images were continuously produced thereby to evaluate durability (break), appearance (damage) and waving of the belt, and jamming (JAM) of papers due to poor runnability.

Appearance: Excellent: No damage
Good: Slight damage, but no influence on image quality
Poor: Abnormal images were produced due to damage

JAM: Excellent: No JAM
Good: 1 to 3 times
Fair: 4 to 7 times
Poor: 8 or more times

The belt broken on the way was evaluated then.

The results are shown in Tables 2-1 to 2-2.

TABLE 2-1

| | Seamless | Cycles | | | |
|---|---|---|---|---|---|
| | Belt | First | Second | Third | Fourth |
| Example 1 | A | Excellent | Excellent | Excellent | Excellent |
| Example 2 | B | Excellent | Good | Good | Fair |
| Example 3 | C | Excellent | Excellent | Good | Fair |
| Example 4 | D | Excellent | Good | Fair | Fair |
| Example 5 | E | Excellent | Excellent | Excellent | Good |
| Example 6 | F | Excellent | Good | Fair | Fair |
| Example 7 | G | Excellent | Excellent | Excellent | Excellent |
| Example 8 | H | Excellent | Fair | Fair | Fair |
| Example 9 | I | Excellent | Good | Good | Fair |
| Example 10 | J | Excellent | Good | Fair | Fair |
| Comparative | K | Good | Fair | Poor | Poor |
| Example 1 | | | | | |
| Comparative | L | Excellent | Excellent | Excellent | Good |
| Example 2 | | | | | |
| Comparative | M | Poor | Poor | Poor | Poor |
| Example 3 | | | | | |

TABLE 2-2

| | Seamless | Continuous Production | | |
|---|---|---|---|---|
| | Belt | Break | Appearance | JAM |
| Example 1 | A | None | Excellent | Excellent |
| Example 2 | B | None | Excellent | Good |
| Example 3 | C | None | Excellent | Excellent |
| Example 4 | D | None | Excellent | Excellent |
| Example 5 | E | None | Excellent | Excellent |
| Example 6 | F | None | Excellent | Excellent |
| Example 7 | G | None | Good | Excellent |
| | | | (edge cracked) | |
| Example 8 | H | None | Excellent | Good |
| Example 9 | I | None | Excellent | Good |
| Example 10 | J | None | Excellent | Excellent |
| Comparative | K | None | Good | Fair |
| Example 1 | | | | |
| Comparative | L | Broke (60,000) | Excellent | Excellent |
| Example 2 | | | | |
| Comparative | M | None | Poor | Poor |
| Example 3 | | | | |

As Tables 2-1 and 2-2 show, each of the seamless belts of Examples provides an intermediate transfer belt having high durability and an image forming apparatus producing high-quality images without uneven image density even after left in an environment of high temperature and high humidity.

Having now fully described the invention, it will be apparent to one of ordinary skill in the art that many changes and modifications can be made thereto without departing from the spirit and scope of the invention as set forth therein.

What is claimed is:

1. An image forming apparatus, comprising:
an image bearer;
an image developer configured to develop a latent image formed on the image bearer with a toner to form a toner image thereon;
a ring-shaped intermediate transfer belt configured to be rotatably stretched by plural tension rollers, and the toner image is first transferred on;
a curving roller configured to contact an outer surface of the intermediate transfer belt the toner image is transferred on and curve the belt inside; and
a transferer configured to secondly transfer the toner image on the intermediate transfer belt to a recording medium,
wherein the intermediate transfer belt has a double-layered structure formed of an inner layer and an outer layer each comprising a same resin.

2. The image forming apparatus of claim 1, wherein the intermediate transfer belt has curl angles not less than 85°, respectively, after wound around a metallic bar having a diameter of 14 mm, contacting the surface side and the backside thereto in an environment of 45° C. 90% RH for 14 days, and taken out therefrom and left by itself for 60 min.

3. The image forming apparatus of claim 1, wherein the intermediate transfer belt comprises a residual solvent in an amount of from 5 to 2,000 ppm at an arbitrary part.

4. The image forming apparatus of claim 1, wherein the outer layer of the intermediate transfer belt has a thickness of from 40 to 60% based on total thickness of the belt.

5. The image forming apparatus of claim 1, wherein the resin of the inner layer and the outer layer is a polyimide resin.

6. The image forming apparatus of claim 1, wherein the resin of the inner layer and the outer layer is a polyamideimide resin.

7. A method of forming a double-layered belt member comprising an inner layer and an outer layer, used in image forming apparatus, comprising:
coating a resin on an outer surface of a cylindrical metal mold and heating the metal mold to form the inner layer;
coating the same resin on the inner layer and heating the metal mold to form the outer layer; and
taking the belt member out from the metal mold after the outer layer is imidized.

8. The method of claim 7, wherein at least the step of heating the metal mold to form the outer layer comprises heating the metal mold from the inside thereof.
